(19) United States
(12) Patent Application Publication
(10) Pub. No.: US 2011/0208974 A1
(43) Pub. Date: Aug. 25, 2011

(54) Countermeasure Against Keystroke Logger Devices

(75) Inventors: Stuart O. Goldman, Scottsdale, AZ (US); Karl F. Rauscher, Emmaus, PA (US)

(73) Assignee: Alcatel-Lucent USA Inc., Murray Hill, NJ (US)

(21) Appl. No.: 12/712,462

(22) Filed: Feb. 25, 2010

(51) Int. Cl. G06F 12/14; G06F 21/00

(52) U.S. Cl. 713/189; 726/18

(57) ABSTRACT

An anti-key logging protocol executable by a computer platform and a corresponding keystroke input device (e.g., keyboard or keypad) functions as a countermeasure to a key logger device. Following an authentication procedure, the computer platform sends encryption parameters to the keystroke input device, and the keystroke input device uses the encryption parameters to scramble or otherwise encrypt keystrokes entered on the keystroke input device before sending them to the computer platform. In such manner, keystrokes and/or keystroke representations sent from the keystroke input device to the computer platform are unrecognizable to a key logger device yet can be decoded by the computer platform.

### FIELD OF THE INVENTION

This invention relates generally to the field of information security and more particularly, to a protective measure against keystroke logger devices.

### BACKGROUND OF THE INVENTION

A keystroke logger is a device that is able to capture (or log) keystrokes executed on a keyboard (e.g., a computer keyboard), typically in a covert manner such that the person entering the keystrokes is unaware that the keystrokes are being monitored. Keystroke loggers can be used for legitimate purposes (such as parental monitoring or law enforcement applications), however they can also be used maliciously by cyber criminals to obtain personal and/or confidential information for illicit purposes. For example, keystroke loggers can be utilized to obtain passwords, user names, personal identification numbers, and personal and/or employer/employee communications entered by unsuspecting users, placing the users and/or their employers at risk of identity theft and financial loss. There is a need to protect unsuspecting users against the malicious use of keystroke logger devices to preclude, or at least reduce the risk of these consequences.

### SUMMARY OF THE INVENTION

This need is addressed and a technical advance is achieved in the art by an anti-key logging protocol executable by a computer platform and a corresponding keystroke input device (e.g., keyboard or keypad), that effectively renders keystrokes entered on the keystroke input device undecipherable to a key logger device. Following an authentication procedure, the computer platform sends encryption parameters to the keystroke input device, and the keystroke input device uses the encryption parameters to scramble keystrokes entered on the keystroke input device before sending them to the computer platform. In such manner, keystrokes and/or keystroke representations sent from the keystroke input device to the computer platform are unrecognizable to a key logger device yet can be decoded by the computer platform.

In one embodiment, there is provided an anti-key logging method executed by a keystroke input device of a computer system, wherein the keystroke input device nominally communicates user keystroke information to a computer platform, and wherein the user keystroke information is susceptible to interception by a key logger device. The keystroke input device obtains user keystroke information and one or more encryption parameters for use in encrypting the user keystroke information; encrypts at least a portion of the user keystroke information according to the encryption parameters, yielding encrypted keystroke information; and communicates the encrypted keystroke information to the computer platform.

In another embodiment, there is provided an anti-key logging method executed by a computer platform of a computer system, wherein the computer platform nominally receives user keystroke information communicated from a keystroke input device, and wherein the user keystroke information is susceptible to interception by a key logger device. Following an authentication procedure, the computer platform sends one or more encryption parameters to the keystroke input device for use in encrypting the user keystroke information. Thereafter, the computer platform receives encrypted keystroke information from the keystroke input device, the encrypted keystroke information having been encrypted by the keystroke input device according to one or more encryption parameters sent from the computer platform; and the computer platform decrypts at least a portion of the encrypted keystroke information, yielding unencrypted keystroke information.

In still another embodiment, there is provided an apparatus for performing an anti-key logging protocol, in accordance with a computer system including a keystroke input device operably connected to a computer platform, wherein the keystroke input device nominally communicates user keystroke information to the computer platform, and wherein the user keystroke information is susceptible to interception by a key logger device. The apparatus at the keystroke input device comprises a memory and a processor configured to obtain user keystroke information and one or more encryption parameters for use in encrypting the user keystroke information; encrypt at least a portion of the user keystroke information according to the encryption parameters, yielding encrypted keystroke information; and communicate the encrypted keystroke information to the computer platform.

In yet another embodiment, there is provided an apparatus for performing an anti-key logging protocol, in accordance with a computer system including a keystroke input device operably connected to a computer platform, wherein the computer platform nominally receives user keystroke information communicated from the keystroke input device, and wherein the user keystroke information is susceptible to interception by a key logger device. The apparatus at the computer platform comprises a memory and a processor configured to send one or more encryption parameters to the keystroke input device for use in encrypting the user keystroke information; receive encrypted keystroke information from the keystroke input device, the encrypted keystroke information having been encrypted by the keystroke input device according to one or more encryption parameters sent from the computer platform; and decrypt at least a portion of the encrypted keystroke information, yielding unencrypted keystroke information.

### BRIEF DESCRIPTION OF THE DRAWINGS

The foregoing and other advantages of the invention will become apparent upon reading the following detailed description and upon reference to the drawings in which:

FIG. 1 is a block diagram of a computer system according to the prior art having vulnerability to a keystroke logger device;

FIG. 2 is a block diagram of a computer system according to embodiments of the present invention including a keystroke input device and computer platform that are operable to execute an anti-key logging protocol as a countermeasure to a keystroke logger device;

FIG. 3 is a flowchart showing steps performed by the keystroke input device of FIG. 2 to execute an anti-key logging protocol;

FIG. 4 is a flowchart showing steps performed by the computer platform of FIG. 2 to execute an anti-key logging protocol; and

FIG. 5 is an activity sequence diagram showing steps performed by the keystroke input device and computer platform of FIG. 2 to execute an anti-key logging protocol.

### DESCRIPTION OF THE PREFERRED EMBODIMENT(S)

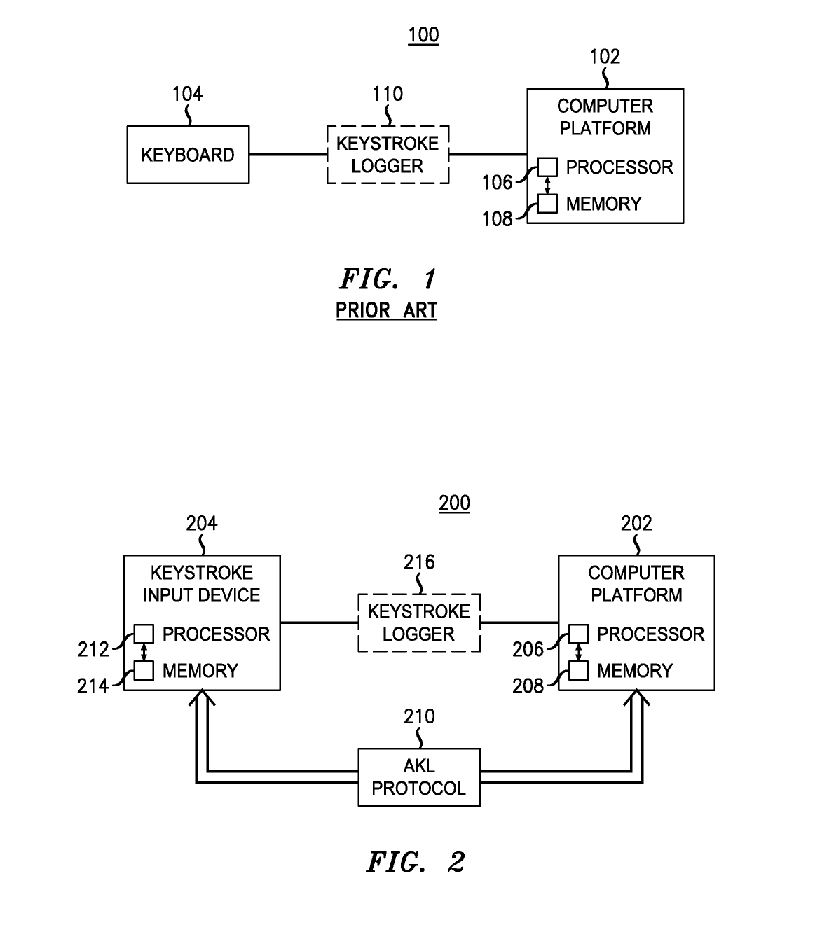

FIG. 1 illustrates an exemplary prior art computer system 100 having vulnerability to a keystroke logger device. The computer system 100 comprises a computer platform 102 operably connected to a keyboard 104. For example, the computer system 100 may comprise a laptop or desktop computer 102 having an associated keyboard 104 (hereinafter, “standard keyboard”), that receives user keystrokes and communicates user keystroke information to the computer platform 102. The standard keyboard 104 typically includes alphabetic characters, numbers, symbols, punctuation symbols and various function or navigation keys; and the keystroke information communicated to the computer platform may comprise indicia of user keystrokes, keystroke combinations, or keystroke representations (e.g., encoded characters, such as ASCII representations of the user keystrokes or keystroke combinations).

The computer platform 102 includes a processor 106 and memory 108, wherein the processor 106 is operable to execute computer program code (e.g., including but not limited to operating system firmware/software and application software) stored in memory 108; which execution may depend at least in part on user input communicated from the keyboard 104. In particular, the processor 106 is operable to execute computer program code responsive at least in part to user keystrokes, keystroke combinations or keystroke representations communicated from the keyboard 104.

As shown, however, the computer system 100 includes a keystroke logger (a.k.a., “keylogger”) 110 operably connected between the keyboard 104 and computer platform 102, that is operable to intercept and record the keystrokes, keystroke combinations or keystroke representations communicated from the keyboard 104 to the computer platform 102. The keystroke logger 110 can be implemented in multiple ways including, without limitation, hardware, software and firmware modalities.

In one example the keystroke logger 110 can be software/firmware-based (e.g., exists at the BIOS-level interface between the processor 106 and other components of the computer platform 102). That is, the BIOS (basic input/output system) can be modified to record keyboard events as they are processed. Implementation requires physical and/or root-level access to the computer platform, and the software loaded into the BIOS needs to be created for the specific hardware that it will be running on.

In another example the keystroke logger 110 can be hardware-based (e.g., a hardware circuit connected somewhere in between the keyboard 104 and computer platform 102), typically in line with the keyboard's cable connector (not shown). For example, a keystroke logger may be integrated onto a PS2 or USB cable connector connecting the keyboard 104 to the computer platform 102. More stealthy implementations can be installed or built into standard keyboards, so that there's no device visible on the external cable. Both types log all keyboard activity to an internal memory which can subsequently be accessed, for example, by subsequently removing and retrieving the external device or by typing in a secret key sequence to retrieve the information captured by the internal application.

Now referring to FIG. 2, there is shown a computer system 200 that is operable according to embodiments of the present invention to execute an anti-key logging protocol as a countermeasure to a keystroke logger device. The computer system 200 comprises a computer platform 202 operably connected to a keystroke input device 204. For example and without limitation, the computer system 200 may comprise a laptop or desktop computer 202 and an associated keyboard 204 (“smart keyboard”), which receives user keystrokes and communicates user keystroke information to the computer platform 202.

The computer platform 202 includes a processor 206 and memory 208, similar to the computer platform 102 of the prior art, wherein the processor 206 is operable to execute computer program code (e.g., including but not limited to operating system firmware/software and application software) stored in memory 208; which execution may depend at least in part on user input communicated from the keystroke input device 204. In particular, the processor 206 is operable to execute computer program code responsive at least in part to user keystrokes, keystroke combinations or keystroke representations communicated from the keystroke input device 204. In a preferred embodiment, the processor 206 executes computer program code defining an anti-key logging protocol (“AKL protocol”) 210 in cooperation with the keystroke input device 204 as a countermeasure to a keystroke logger device. For example and without limitation, the AKL protocol 210 may comprise application software stored in memory 208.

The keystroke input device (a.k.a., “smart keyboard”) 204 includes a processor 212 and memory 214, wherein the processor 212 is operable to execute certain aspects of the AKL protocol 210 in cooperation with the computer platform 202 (i.e., the processor 206 of the computer platform) as a countermeasure to a keystroke logger device. Similarly to a standard keyboard, the smart keyboard 204 may also include alphabetic characters, numbers, symbols, punctuation symbols and various function or navigation keys; and may communicate keystroke information to the computer platform 202 comprising indicia of user keystrokes, keystroke combinations, or keystroke representations (e.g., encoded characters, such as ASCII representations of the user keystrokes or keystroke combinations). Alternatively or additionally, the keystroke input device 204 may characterize a keypad, such as a numeric or alphanumeric keypad.

As shown, the computer system 200 may include a keystroke logger 216 operably connected between the keystroke input device 204 and computer platform 202, that is deployed in an attempt to intercept and record the keystrokes, keystroke combinations or keystroke representations communicated from the keystroke input device 204 to the computer platform 202. The keystroke logger 216 may comprise, as described in relation to FIG. 1, a hardware, software or firmware-based device. However, according to embodiments of the present invention, the computer platform 202 and keystroke input device 204 may execute an AKL protocol 210 as a keystroke logging countermeasure, to render keystrokes and/or keystroke representations sent from the keystroke input device 204 to the computer platform unrecognizable to the keystroke logger 216, most particularly in the case of a hardware- or software/firmware-based keystroke logger.

As will be appreciated, the components of FIG. 2 are functional components that may be distributed among multiple individual components or devices. For example and without limitation, the keystroke input device 204 and computer platform 202 may be integrated onto a single device or distributed among multiple devices; and the AKL protocol 210 may be stored in a single device or distributed among multiple devices.

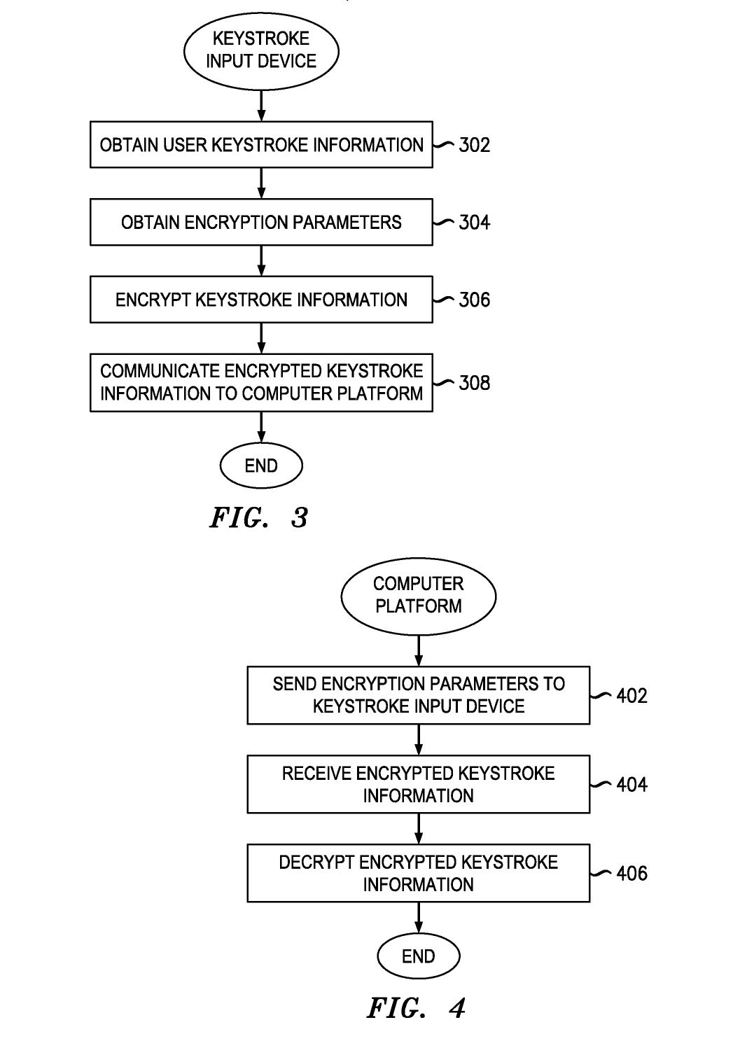

FIG. 3 is a flowchart showing steps performed by a keystroke input device to execute an anti-key logging protocol. Referring to FIG. 2, the steps of FIG. 3 may be performed, for example, by a keystroke input device (“smart keyboard”) 204 having a processor 212 and memory 214, that is operably connected to a computer platform 202 running an AKL protocol 210.

At step 302, the keystroke input device obtains user keystroke information. The term “keystroke information” will be understood to include, without limitation, indicia of user keystrokes, keystroke combinations, or keystroke representations. For example, responsive to user keystroke activity, the keystroke input device identifies one or more instances of user keystrokes and/or keystroke combinations; and optionally, formulates one or more instances of keystroke representations (e.g., encoded characters, such as ASCII representations) corresponding to the user keystrokes and/or keystroke combinations.

At step 304, the keystroke input device obtains one or more encryption parameters for use in encrypting the user keystroke information. And at step 306, the keystroke input device encrypts at least a portion of the user keystroke information according to the encryption parameters, yielding encrypted keystroke information.

The encryption parameters may define generally, any encoding, scrambling or masking scheme that transforms the keystroke information, or renders the keystroke information substantially unintelligible to an unauthorized party or device, such as a keystroke logger device. The terms “encryption” or “encrypted” as used herein, are therefore broadly defined as encompassing any of several encoding, scrambling or masking algorithms presently known or devised in the future. As will be appreciated, the encryption parameters can be imposed upon one or more instances of keystroke information and can vary greatly in sophistication and complexity depending on implementation of the AKL protocol. As one example and without limitation, it is contemplated that the encryption parameters might comprise a very simple scrambling scheme whereby an original character is shifted n positions in a known sequence (for example, shifting forward 3 characters in an alphabetic sequence, the character “a” would be represented by the character “d”). Alternatively or additionally, of course, the encryption parameters may also comprise any number of more complex encoding, scrambling or masking schemes.

In one embodiment, the keystroke input device 204 obtains encryption parameters at step 304 from the computer platform 202, initially following an authentication sequence whereby the computer platform 202 confirms the identity of the keystroke input device, and then periodically thereafter for so long as the authentication is valid. For example and without limitation, the computer platform may update encryption parameters after designated time intervals, upon occurrence of designated events, or upon request from the keystroke input device. In such manner the computer platform knows which encryption parameters will be used by the keystroke input device to encrypt the user keystroke information. Alternatively or additionally, the keystroke input device may receive encryption parameters from an external platform (i.e., other than the computer platform 202) or it may retrieve encryption parameters from its own memory 214, for so long as the computer platform 202 will know or can determine which encryption parameters will be used by the keystroke input device to encrypt the user keystroke information.

Finally at step 308, the keystroke input device communicates the encrypted keystroke information to the computer platform. Thereafter, as will be described in greater detail in relation to FIG. 4, the computer platform decodes the encrypted keystroke information to yield unencrypted keystroke information; and the computer platform executes computer program code, performs certain functions or the like responsive at least in part to the unencrypted keystroke information.

FIG. 4 is a flowchart showing steps performed by a computer platform to execute an anti-key logging protocol. Referring to FIG. 2, the steps of FIG. 4 may be performed, for example, by a computer platform 202 having a processor 206 and memory 208 that is running a software application defining an AKL protocol 210, and that is operably connected to a keystroke input device (“smart keyboard”) 204.

At step 402, the computer platform sends one or more encryption parameters to the keystroke input device 204. As noted with respect to FIG. 3, the encryption parameters may define generally, any encoding, scrambling or masking algorithm that may be used by the keystroke input device to transform keystroke information, rendering the keystroke information substantially unintelligible to an unauthorized party or device, such as a keystroke logger device. In one embodiment, the computer platform sends the encryption parameters to the keystroke input device following an authentication sequence whereby the computer platform 202 confirms the identity of the keystroke input device, and then periodically thereafter for so long as the authentication is valid. For example and without limitation, the computer platform may update encryption parameters after designated time intervals, upon occurrence of designated events, or upon request from the keystroke input device. In such manner the computer platform knows which encryption parameters will be used by the keystroke input device to encrypt the user keystroke information.

Thereafter, at step 404, the computer platform receives encrypted keystroke information from the keystroke input device 204, the encrypted keystroke information having been encrypted according to the encryption parameters provided by the computer platform. At step 406, the computer platform decodes the encrypted keystroke information to yield unencrypted keystroke information; and the computer platform executes computer program code, performs certain functions or the like responsive at least in part to the unencrypted keystroke information.

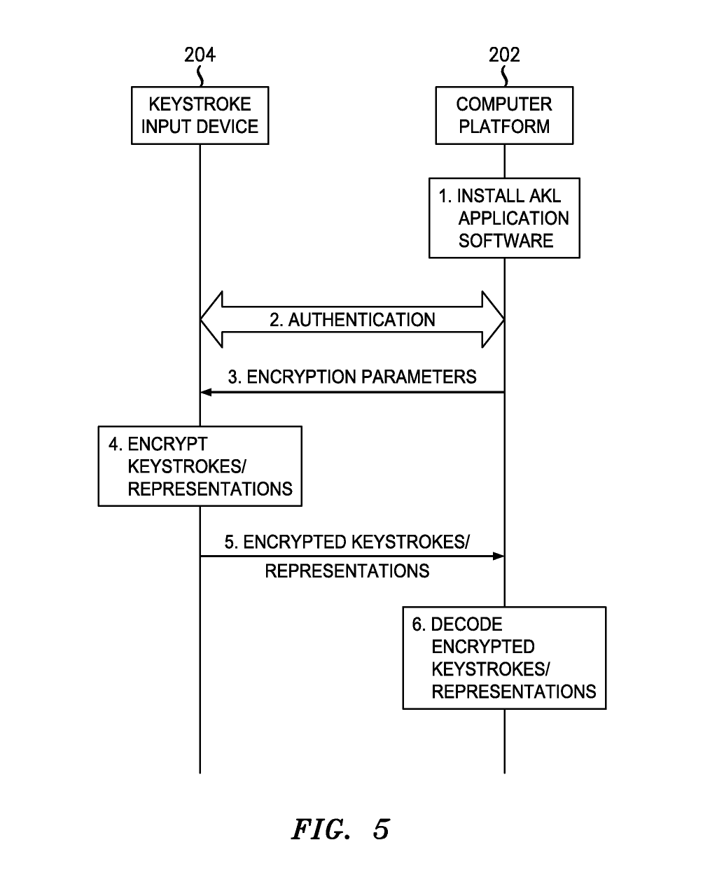

Now turning to FIG. 5, there is shown an activity sequence diagram showing steps performed by a keystroke input device and computer platform to execute an anti-key logging protocol. Referring to FIG. 2, the steps of FIG. 5 may be performed, for example, by a keystroke input device (“smart keyboard”) 204 that is operably connected to a computer platform 202.

At step 1, an anti-key logging (AKL) software application is loaded into the computer platform, for example and without limitation, by the computer owner or someone with sufficient administrative privileges. The AKL software application may be loaded in generally any manner presently known or devised in the future. In one embodiment, upon installation of the AKL software application, the computer platform will send a message to an administrator informing the administrator that it has been installed.

At step 2, the computer platform will execute an authentication procedure in cooperation with the keystroke input device, i.e., to confirm the identity of the keystroke input device. In one embodiment, the authentication procedure is initiated by the computer platform querying the keystroke input device for a unique “keyboard ID” or other suitable indicia of identity. The request may be initiated, for example and without limitation, after initial installation and upon receiving a first instance of keystroke information from the keystroke input device. Responsive to the query, the keystroke input device retrieves the keyboard ID from memory 214 and sends indicia of the keyboard ID to the computer platform; and the computer platform confirms the validity of the keyboard ID by checking a database or the like.

At step 3, if the keyboard ID is determined to be valid, the computer platform sends one or more encryption parameters to the keystroke input device. In one embodiment, the computer platform periodically updates the encryption parameters (e.g., sends new encryption parameters) at startup or other events, at certain time intervals, or as initiated by the operator or administrator. Optionally, the computer platform may reconfirm the identity of the keystroke input device before updating the encryption parameters.

At step 4, the keystroke input device encrypts at least a portion of the user keystroke information according to the encryption parameters, yielding encrypted keystrokes and/or keystroke representations. And at step 5, the keystroke input device sends the encrypted keystrokes and/or keystroke representations to the computer platform. At step 6, the computer platform decodes the encrypted keystroke information to yield unencrypted keystroke information; and the computer platform executes computer program code, performs certain functions or the like responsive at least in part to the unencrypted keystroke information.

FIGS. 1-5 and the foregoing description depict specific exemplary embodiments of the invention to teach those skilled in the art how to make and use the invention. The described embodiments are to be considered in all respects only as illustrative and not restrictive. The present invention may be embodied in other specific forms without departing from the scope of the invention which is indicated by the appended claims. All changes that come within the meaning and range of equivalency of the claims are to be embraced within their scope.

For example, the term “computer platform” as used herein is generally defined as a computer resource having a processor and memory, wherein the processor is operable to execute computer program code (e.g., including but not limited to operating system firmware/software and application software) stored in memory; and which nominally receives user keystroke information communicated from a keystroke input device (e.g., keyboard or keypad). The processor may comprise one or more processing devices, including a central processing unit (CPU) or other processing circuitry, including but not limited to one or more signal processors, integrated circuits or the like. The memory may comprise memory associated with the processor or CPU, such as random-access memory (RAM) or read-only memory (ROM), a fixed memory device (e.g., hard drive), or a removable memory device (e.g., diskette or CD ROM).

The term “keystroke input device” as used herein is generally defined as a user input device that is operably connected to the computer platform, which receives user keystrokes and communicates user keystroke information to the computer platform.

For example and without limitation, the keystroke input device may comprise a keyboard, such as a personal computer keyboard, including alphabetic characters, numbers, symbols, punctuation symbols and various function or navigation keys; and the keystroke information may comprise indicia of user keystrokes, keystroke combinations, or keystroke representations (e.g., ASCII representations of user keystrokes or combinations). [ASCII refers to the American Standard Code for Information Interchange]. Alternatively, the keystroke input device may comprise a keypad, such as a numerical keypad. In one embodiment, the keystroke input device comprises a “smart” keyboard having a processor and memory operable to execute an anti-key logging protocol.

What is claimed is:

1. In a computer system including a keystroke input device operably connected to a computer platform, wherein the keystroke input device nominally communicates user keystroke information to the computer platform, and wherein the user keystroke information is susceptible to interception by a key logger device, a method comprising the keystroke input device performing steps of:
obtaining user keystroke information;
obtaining one or more encryption parameters for use in encrypting the user keystroke information;
encrypting at least a portion of the user keystroke information according to the encryption parameters, yielding encrypted keystroke information; and
communicating the encrypted keystroke information to the computer platform.

2. The method of claim 1, wherein the step of obtaining one or more encryption parameters comprises receiving encryption parameters from the computer platform.

3. The method of claim 2, wherein the step of receiving encryption parameters from the computer platform is preceded by a step of sending authentication information to the computer platform.

4. The method of claim 1, wherein the step of obtaining user keystroke information comprises one or more of:
identifying one or more instances of user keystrokes executed via the keystroke input device; and
identifying one or more instances of keystroke representations corresponding to user keystrokes executed via the keystroke input device.

5. In a computer system including a keystroke input device operably connected to a computer platform, wherein the computer platform nominally receives user keystroke information communicated from the keystroke input device, and wherein the user keystroke information is susceptible to interception by a keystroke logger device, a method comprising the computer platform performing steps of:
sending one or more encryption parameters to the keystroke input device for use in encrypting the user keystroke information;
receiving encrypted keystroke information from the keystroke input device, the encrypted keystroke information having been encrypted by the keystroke input device according to one or more encryption parameters sent from the computer platform; and
decrypting at least a portion of the encrypted keystroke information, yielding unencrypted keystroke information.

6. The method of claim 5, wherein the step of sending is preceded by a step of authenticating the keystroke input device.

7. The method of claim 6, wherein the step of authenticating comprises:
querying the keystroke input device for authentication information;
receiving authentication information from the keystroke input device; and
determining validity of the authentication information.

8. The method of claim 5, wherein the step of decrypting encrypted keystroke information, yielding unencrypted keystroke information, comprises one or more of:
identifying one or more instances of user keystrokes executed via the keystroke input device; and
identifying one or more instances of keystroke representations corresponding to user keystrokes executed via the keystroke input device.

9. Apparatus for performing an anti-key logging protocol, in accordance with a computer system including a keystroke input device operably connected to a computer platform, wherein the keystroke input device nominally communicates user keystroke information to the computer platform, and wherein the user keystroke information is susceptible to interception by a key logger device, the apparatus at the keystroke input device comprising:
a memory; and
at least one processor coupled to the memory and configured to:
obtain user keystroke information;
obtain one or more encryption parameters for use in encrypting the user keystroke information;
encrypt at least a portion of the user keystroke information according to the encryption parameters, yielding encrypted keystroke information; and
communicate the encrypted keystroke information to the computer platform.

10. Apparatus for performing an anti-key logging protocol, in accordance with a computer system including a keystroke input device operably connected to a computer platform, wherein the computer platform nominally receives user keystroke information communicated from the keystroke input device, and wherein the user keystroke information is susceptible to interception by a key logger device, the apparatus at the computer platform comprising:
a memory; and
at least one processor coupled to the memory and configured to:
send one or more encryption parameters to the keystroke input device for use in encrypting the user keystroke information;
receive encrypted keystroke information from the keystroke input device, the encrypted keystroke information having been encrypted by the keystroke input device according to one or more encryption parameters sent from the computer platform; and
decrypt at least a portion of the encrypted keystroke information, yielding unencrypted keystroke information.
